(19) United States
(12) Patent Application Publication
(10) Pub. No.: US 2017/0091886 A1
(43) Pub. Date: Mar. 30, 2017

(54) METHODS, SYSTEMS, AND COMPUTER READABLE MEDIA FOR OPTIMIZED CASE MANAGEMENT

(71) Applicant: Craig Nickles Ackley, Wake Forest (US)

(72) Inventor: Craig Nickles Ackley, Wake Forest (US)

(21) Appl. No.: 15/278,931

(22) Filed: Sep. 28, 2016

Related U.S. Application Data
(60) Provisional application No. 62/233,756, filed on Sep. 28, 2015.

(51) Int. Cl. G06Q 50/18; G06F 17/30; G06F 17/21; G06Q 10/10

(52) U.S. Cl. CPC G06Q 50/18; G06Q 10/10; G06F 17/30011; G06F 17/211; G06F 17/30707

(57) ABSTRACT

Methods, systems, and computer readable media for optimized case management are disclosed. According to one exemplary method for optimized case management, the method includes importing one or more documents associated with a case. The method also includes providing an interface for importing one or more documents associated with a case and for inputting classification details about the one or more documents. The method further includes generating, using the classification details, a report containing links to a subset of the one or more documents, where the links in the report are ordered based on the classification details. The method further includes providing, to a requesting entity, the report.

### RELATED APPLICATIONS

This application claims the benefit of U.S. Provisional Patent Application Ser. No. 62/233,756, filed Sep. 28, 2015; the disclosure of which is incorporated herein by reference in its entirety.

### TECHNICAL FIELD

The subject matter described herein relates to data management. More specifically, the subject matter relates to methods, systems, and computer readable media for optimized case management.

### BACKGROUND

Case management software is generally useful for maintaining information about various aspects of criminal and/or civil cases, including information used during trials or litigation. However, case management software generally provides limited organization, sort, search, and analysis functions.

Accordingly, a need exists for improved methods, systems, and computer readable media for optimized case management.

### SUMMARY

Methods, systems, and computer readable media for optimized case management are disclosed. According to one method for optimized case management, the method includes providing an interface for importing one or more documents associated with a case and for inputting classification details about the one or more documents. The method also includes generating, using the classification details, a report containing links to a subset of the one or more documents, where the links in the report are ordered based on the classification details. The method further includes providing, to a requesting entity, the report.

According to one system for optimized case management, the system includes at least one processor and memory. The system also includes a case management module utilizing the at least one processor and the memory. The case management module is configured to provide an interface for importing one or more documents associated with a case and for inputting classification details about the one or more documents, to generate, using the classification details, a report containing links to a subset of the one or more documents, where the links in the report are ordered based on the classification details, and to provide, to a requesting entity, the report.

The subject matter described herein may be implemented in software in combination with hardware and/or firmware. For example, the subject matter described herein may be implemented in software executed by a processor. In some implementations, the subject matter described herein may be implemented using a computer readable medium having stored thereon computer executable instructions that when executed by the processor of a computer cause the computer to perform steps. Exemplary computer readable media suitable for implementing the subject matter described herein include non-transitory devices, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

As used herein, the term “node” refers to a physical computing platform including one or more processors and memory.

As used herein, the terms “function” or “module” refer to hardware, firmware, or software in combination with hardware and/or firmware for implementing features described herein.

### BRIEF DESCRIPTION OF THE DRAWINGS

The subject matter described herein will now be explained with reference to the accompanying drawings of which:

FIG. 1 is a high level block diagram illustrating a case management module according to an embodiment of the subject matter described herein;

FIG. 2 is a diagram illustrating generating a report containing links according to an embodiment of the subject matter described herein

FIG. 3 is a screenshot illustrating a user interface (UI) for importing files according to an embodiment of the subject matter described herein;

FIG. 4 is a screenshot illustrating a UI for organizing files according to an embodiment of the subject matter described herein;

FIG. 5 is a screenshot illustrating a UI for analyzing files according to an embodiment of the subject matter described herein;

FIG. 6 is a screenshot illustrating a UI for generating a report according to an embodiment of the subject matter described herein;

FIG. 7 is a screenshot illustrating a generated report according to an embodiment of the subject matter described herein;

FIG. 8 is a screenshot illustrating a report containing a case file index according to an embodiment of the subject matter described herein; and

FIG. 9 is a diagram illustrating a process for optimized case management according to an embodiment of the subject matter described herein.

### DETAILED DESCRIPTION

The subject matter described herein relates to methods, systems, and computer readable media for optimized case management. Conventional case management software lacks organization, searching, reporting, and/or configurability features associated with managing numerous files and/or data types. For example, an attorney may obtain hundreds or thousands of separate pieces of information, including documents, sound files, images, video files, etc., regarding a legal matter. In this example, the attorney may wish to arrange the pieces of information in a coherent and orderly fashion for quick and easy reference before and/or during a trial. However, while conventional case management software may provide logging of the information in a table or database, such software generally lacks the ability to easily sort, search, organize, analyze, and/or output this information in an easy, portable format.

In accordance with some aspects of the subject matter described herein, methods, systems, and/or techniques are provided for optimizing case management by generating, using user-defined classification details, a report containing links to one or more files. For example, a case management module (e.g., software executing on a physical processor or a case management system) may be configured to provide a user interface for uploading one or more files, for providing classification details (e.g., categories, subcategories, labels, keywords, and/or notes) about the one or more files, and/or for providing user preferences. In this example, the case management module may convert and/or generate versions (e.g., portable document format (PDF) files) of the one or more files and may generate a report containing links to the one or more files (e.g., a PDF file containing hyperlinks) based on classification details and/or user preferences.

Reference will now be made in detail to various embodiments of the subject matter described herein, examples of which are illustrated in the accompanying drawings. Wherever possible, the same reference numbers will be used throughout the drawings to refer to the same or like parts.

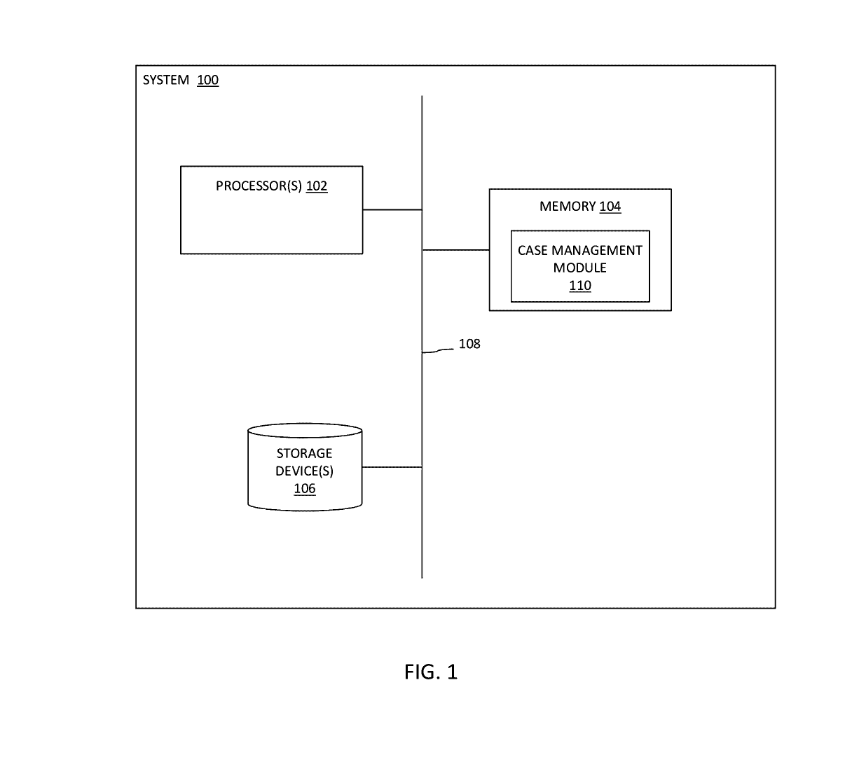

FIG. 1 depicts a high level block diagram of a computer system 100 suitable for use in performing one or more of the functions described herein. As depicted in FIG. 1, computer system 100 includes one or more processor(s) 102, a memory 104, and one or more storage device(s) 106 communicatively connected via a system bus 108. In some embodiments, processor(s) 102 can include a microprocessor, central processing unit (CPU), or any other like hardware based processing unit. In some embodiments, logic and/or instructions (e.g., software) can be stored in memory 104, which can include random access memory (RAM), read only memory (ROM), optical read/write memory, cache memory, magnetic read/write memory, flash memory, or any other non-transitory computer readable medium. In some embodiments, processor(s) 102 and memory 104 can be used to execute and manage various functions and/or logic associated with optimized case management. In some embodiments, storage device(s) 106 can include any storage medium or storage unit that is configured to store data accessible by processor(s) 102 via system bus 108. Exemplary storage devices can include one or more local databases hosted by computer system 100.

In some embodiments, memory 104 may include a case management module 110. Case management module 110 may represent any suitable entity for performing aspects associated with optimized case management. For example, case management module 110 may include software and/or other logic for providing one or more user interfaces (e.g., a graphical user interface (GUI) or a command line interface (CLI)) and for performing data organization data analysis, and report generation.

In some embodiments, case management module 110, e.g., via a user interface, may import various files. For example, importing files may include converting files from one file format (e.g., a text document, a video file, an image file, or an audio file) to another file format (e.g., a portable document format (PDF) format). In some embodiments, importing files may include generating a document (e.g., a PDF file) as a placeholder and may include a hyperlink for accessing a video file, a sound file, an image file, or a non-text based file associated with the case. In some embodiments, importing files may include using metadata from the original files.

In some embodiments, case management module 110, e.g., via a user interface, may receive classification details about one or more imported files. For example, classification details may include associating labels, notes, keywords, and/or categories or subcategories with one or more imported files. Some examples of classification details may include a case related category, a witness related category, an evidence related category, an intent related category, a motive related category, a timeline related category, an investigator related category, a data type category, a source related category, or a destination related category.

In some embodiments, case management module 110 may store imported files, classification details, user preferences, and/or other data in storage device(s) 106. For example, various data structures and/or file folders may be used to store data and/or files associated with a particular case. In this example, the various data structures and/or file folders may be indexed and/or searchable using keywords and/or other search criteria.

In some embodiments, case management module 110 may generate a report using classification details and/or other information, such as user preferences, historical data, and/or report preferences. For example, assuming case management module 110 has imported files pertaining to a legal matter and various elements related to a legal defense have been identified and inputted as classification details for one or more relevant files among the imported files, a defense attorney may generate a report file or a section therein that includes notes and/or links (e.g., hyperlinks) to each relevant file or portion therein regarding the legal defense. In this example, the defense attorney may use the report file as a reference when outlining the legal defense during the trial.

In another example, assuming case management module 110 has imported files pertaining to a murder trial and various evidence (e.g., witness statements, text messages, admissions, etc.) related to a motive for murder has been identified and inputted as classification details for one or more relevant files among the imported files, a prosecuting attorney may generate a report file or a section therein that includes notes and/or links to each relevant file or portion therein regarding the motive for murder. In this example, the prosecuting attorney may use the report file as a reference when establishing a motive during the trial.

In another example, assuming case management module 110 has imported files pertaining to a trial and a timeline (e.g., a time and/or a date) for various events has been identified and inputted as classification details for one or more relevant files among the imported files, an attorney may generate a report file or a section therein that includes notes and/or links to each relevant file or portion therein regarding the timeline. In this example, the attorney may use the report file as a reference when establishing a timeline during the trial.

In another example, assuming case management module 110 has imported files pertaining to a legal matter and bates stamps have been added to evidence related files for a particular party in a legal matter, an attorney may generate a report file or a section in the report file that includes links to each evidence related file. In this example, the attorney may use the report file to efficiently provide opposing counsel with evidence, e.g., during a legal discovery process.

It will be appreciated that while various examples described herein relate to legal matters, various aspects of the subject matter described herein may be usable to import, organize, and/or output data associated with any matter, event, or situation. For example, case management module 110 or related functionality may be usable for importing, classifying, organizing and/or reporting about financial matters (e.g., taxes and/or wealth management), personal matters (e.g., hobbies, journaling, and/or video and/or photo collections), and/or other matters.

It will also be appreciated that the above described modules, components, and nodes are for illustrative purposes and that features or portions of features described herein may be performed by different and/or additional modules, components, or nodes. It will also be appreciated that some modules and/or components may be combined and/or integrated.

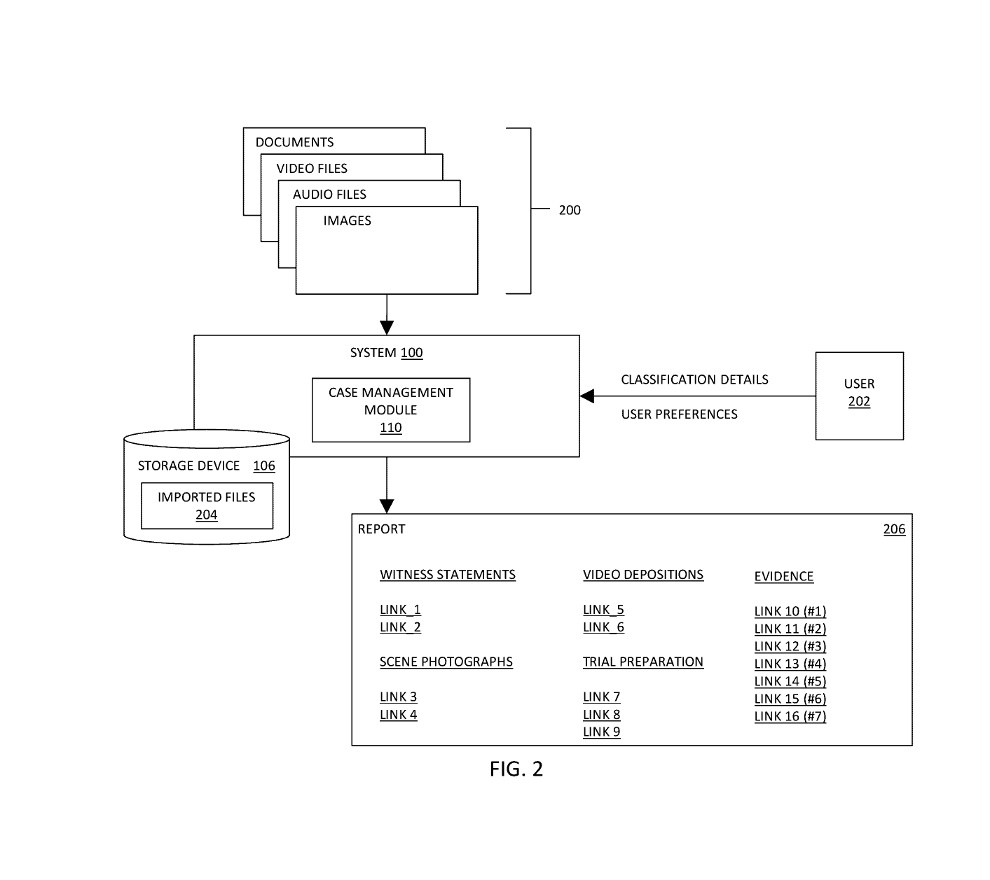

FIG. 2 is a diagram illustrating generating a report containing links according to an embodiment of the subject matter described herein. Referring to FIG. 2, files 200 may be imported and/or converted by case management module 110. For example, files 200 may include documents, video files, audio files, and images.

In some embodiments, versions of files 200 may be stored as imported files 204 in storage device(s) 106. For example, imported files 204 may represent files 200 after being converted and/or stored using one or more file formats, such as PDF, hypertext markup language (HTML), extensible markup language (XML), etc.

In some embodiments, e.g., prior to, after, or concurrently with importing files 200, a user 202 (e.g., a human operator or classification software) may provide classification details and/or user preferences associated with case management, reporting, and/or data organization. For example, user 202 may label certain documents as important, very important, or irrelevant. In another example, user 202 may label or categorize different portions of a file with different labels, keywords, and/or notes. In another example, user 202 may indicate that user preferences such that a report contains links in alphabetical order and/or based on select categories.

Report 206 may include any suitable entity (e.g., a PDF file, a word (e.g., .doc) document, a web page, a help file, etc.) for providing access to numerous related files or pieces of information. In some embodiments, report 206 may include a file containing links (e.g., hyperlinks) to one or more files. In some embodiments, report 206 may act as a directory or table of contents. For example, a report may have various links under one or more categories or subcategories. In this example, report 206 may indicate various metadata for different categories, such as bates stamps for evidence related links, timestamps for other witness statements, and filing dates for court briefs or petitions.

In some embodiments, report 206 may include multiple files stored in one or more data structures or file folders. For example, report 206 may include a PDF file including links to other files, where the other files may be stored in a local file folder. In this example, report 206, including the local file folder, may be copied to a flash drive, a CD, or another storage media for portability.

It will be appreciated that FIG. 2 is for illustrative purposes and that additional and/or different steps and/or data than those depicted in FIG. 2 can be usable for generating report 206.

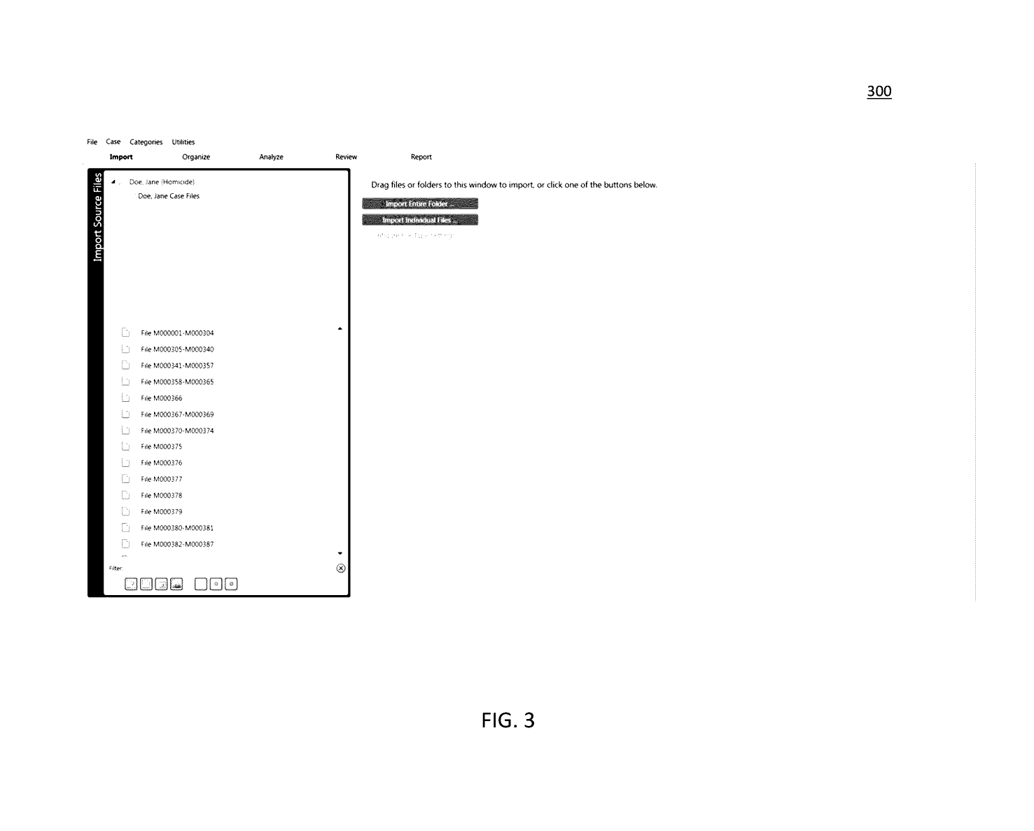

FIG. 3 is a screenshot illustrating a user interface (UI) 300 for importing files according to an embodiment of the subject matter described herein. For example, UI 300 may be usable for importing files and/or folders for case management related purposes. In this example, after importing, files or portions thereof may be organized, analyzed, and/or used in generating one or more reports. In some embodiments, case management module 110 can generate and/or provide a GUI for importing files and/or entire folders. In some embodiments, UI 300 may be a web-based UI and may use hypertext markup language (HTML) or other web related technology.

As illustrated in FIG. 3, UI 300 may provide user interface elements for performing various actions associated with importing files or folders containing one or more files. In some embodiments, UI 300 may provide UI elements that are interactive and/or allow a user to interact with and/or instruct case management module 110 or a related entity. For example, UI 300 may provide a button UI element for importing an entire folder and a button UI element for importing individual files.

UI 300 may also provide UI elements for configuring import settings and/or file type settings associated with imported files. For example, UI 300 may provide UI elements (e.g., check boxes and/or input boxes) for selecting whether an imported document is to be converted into a searchable text document using optical character recognition (OCR) technologies and/or for determining what format to store an imported file or information therein. In another example, UI 300 may provide UI elements (e.g., check boxes and/or input boxes) for inputting compression settings and/or security settings (e.g., password protection preferences) for imported files or information therein.

UI 300 may also provide UI elements for importing a portion of a file and/or for generating multiple imported files from a source file. For example, UI 400 may provide UI elements that allow file viewing, re-naming, deleting, moving, editing, merging, splitting, redacting, or other file related activities.

In some embodiments, UI 300 may present imported folders and/or files using one or more UI elements. For example, UI 300 may use a “treeview” UI element for displaying imported folders and subfolders in hierarchical (e.g., tree-like) manner and a “listview” UI element for displaying a list of imported files associated with a selected (e.g., highlighted) folder or subfolder from the “treeview” UI element. In some embodiments, UI 300 may provide a UI element (e.g., an input box) for filtering or searching for particular files and/or folders based on various keywords and/or other attributes.

It will be appreciated that UI 300 is for illustrative purposes and that different UI elements and layout designs may be used for receiving input and/or for providing actions, feedback, or information to users.

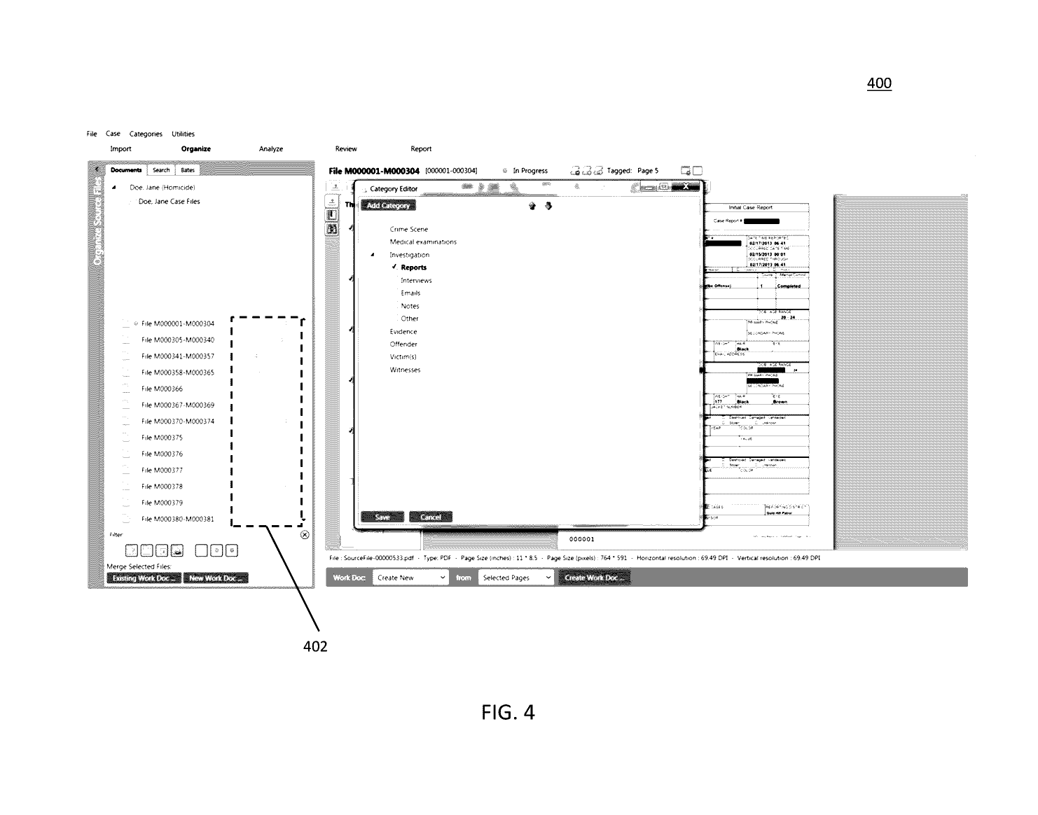

FIG. 4 is a screenshot illustrating a UI 400 for organizing files according to an embodiment of the subject matter described herein. For example, UI 400 may be usable for organizing files and/or folders for case management related purposes. In some embodiments, case management module 110 can generate and/or provide a GUI for organizing files and/or entire folders into various categories. In some embodiments, UI 400 may be a web-based UI and may use hypertext markup language (HTML) or other web related technology.

As illustrated in FIG. 4, UI 400 may provide user interface elements for performing various actions associated with organizing files or folders. In some embodiments, UI 400 may provide UI elements that are interactive and/or allow a user to interact with various imported files.

In some embodiments, UI 400 may provide UI elements that are interactive and/or allow a user to interact with case management module 110 or a related entity. For example, UI 400 may provide UI elements for adding, deleting, and/or editing categories of which files and/or folders can be assigned. In another example, UI 400 may provide UI elements for selecting or assigning categories to one or more files and/or folders.

In some embodiments, UI 400 may present imported folder and/or files using one or more UI elements. For example, UI 400 may use a “treeview” UI element for displaying imported folders and subfolders in hierarchical manner and a “listview” UI element for displaying a list of imported files associated with a selected (e.g., highlighted) folder or subfolder from the “treeview” UI element. In some embodiments, UI 400 may provide a UI element (e.g., an input box) for allowing a user to filter or search for particular files and/or folders based on various keywords and/or other attributes.

In some embodiments, UI 400 may provide a bates stamping option. For example, when a file is selected in a “listview” UI element, a context (e.g., right click) menu may be displayed with one or more options, including a “Bate Stamp Selected Files” option. As depicted in FIG. 4, UI area 402 depicts bates stamps associated with different imported files.

It will be appreciated that UI 400 is for illustrative purposes and that different UI elements and layout designs may be used for receiving input and/or for providing actions, feedback, or information to users.

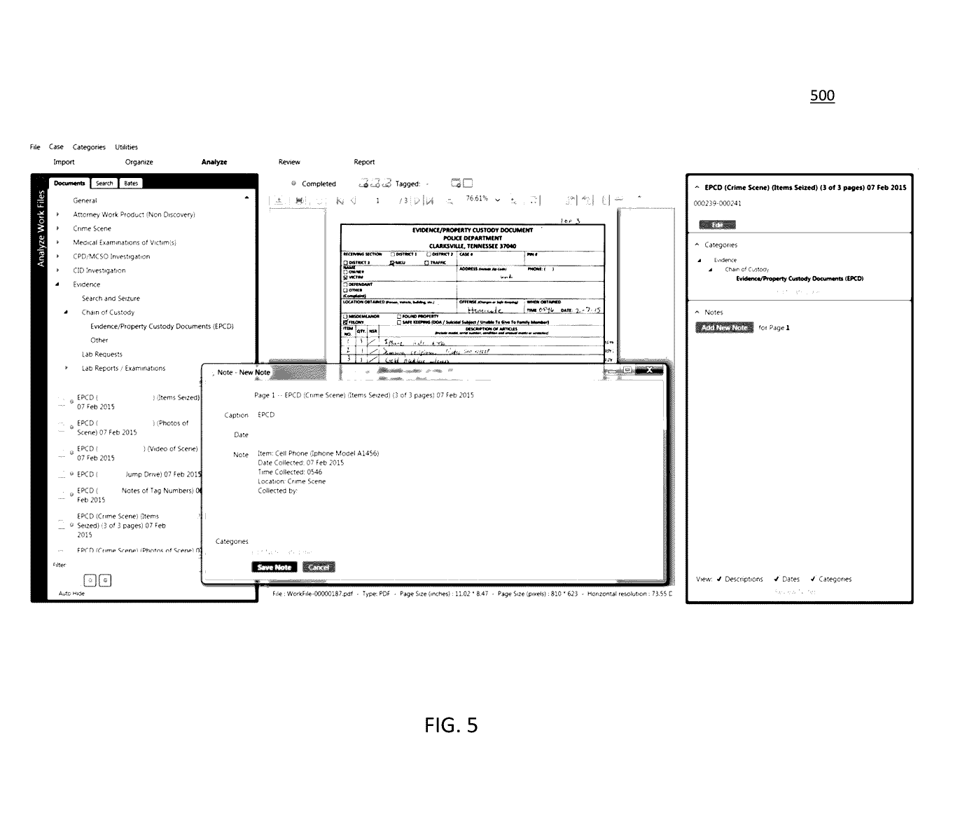

FIG. 5 is a screenshot illustrating a UI 500 for analyzing files according to an embodiment of the subject matter described herein. For example, UI 500 may be usable for analyzing files and/or folders for case management related purposes. In some embodiments, case management module 110 can generate and/or provide a GUI for analyzing files and/or entire folders and for making notes or annotations. In some embodiments, UI 500 may be a web-based UI and may use hypertext markup language (HTML) or other web related technology.

As illustrated in FIG. 5, UI 500 may provide user interface elements for performing various actions associated with analyzing files or folders. In some embodiments, UI 500 may provide UI elements that are interactive and/or allow a user to interact with various imported files. For example, UI 500 may provide a UI element that allows file viewing, re-naming, deleting, moving, editing, merging, splitting, redacting, or other file related activities.

In some embodiments, UI 500 may provide UI elements that are interactive and/or allow a user to interact with case management module 110 or a related entity. For example, UI 500 may provide UI elements for adding, deleting, and/or editing notes or annotations related to files and/or folders. In this example, UI 500 may also provide UI elements for selecting or assigning categories to one or more notes and/or annotations.

In some embodiments, UI 500 may present imported folders and/or files using one or more UI elements. For example, UI 500 may use a “treeview” UI element for displaying imported folders and subfolders in hierarchical manner and a “listview” UI element for displaying a list of imported files associated with a selected (e.g., highlighted) folder or subfolder from the “treeview” UI element. In some embodiments, UI 500 may provide a UI element (e.g., an input box) for allowing a user to filter or search for particular files and/or folders based on various keywords and/or other attributes.

In some embodiments, UI 500 may provide UI elements to indicate a work status associated with a given file. For example, when a file is selected in a “listview” UI element, a context (e.g., right click) menu may be displayed with one or more options with one or more options, including “Mark Not Started”, “Mark In Progress”, and “Mark Completed” options.

It will be appreciated that UI 500 is for illustrative purposes and that different UI elements and layout designs may be used for receiving input and/or for providing actions, feedback, or information to users.

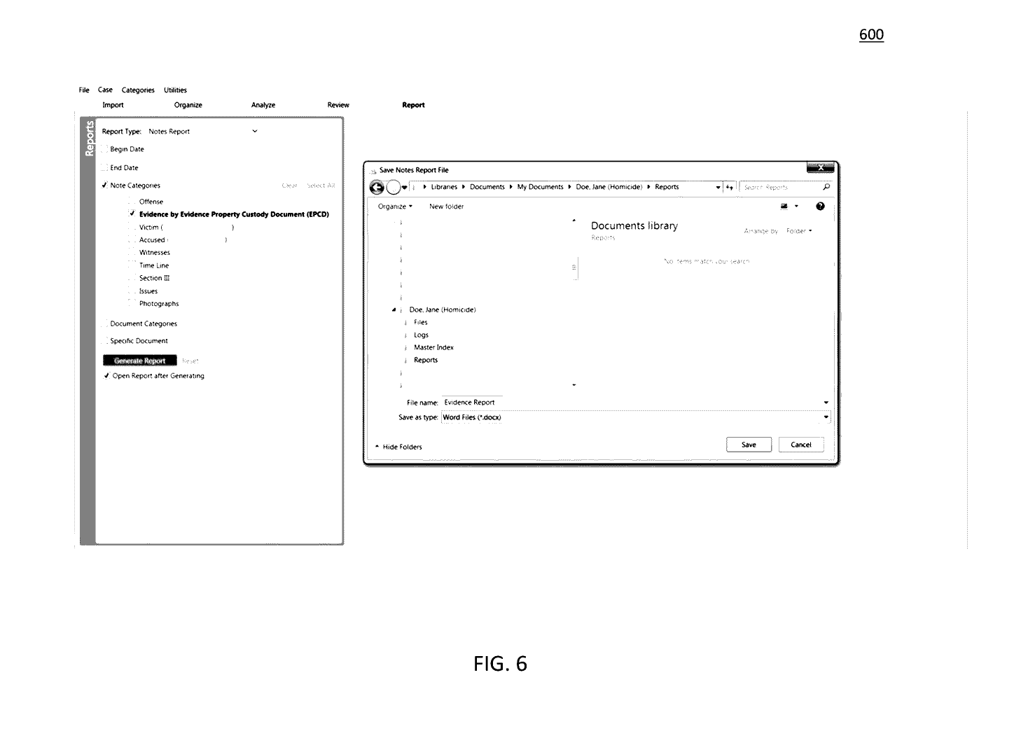

FIG. 6 is a screenshot illustrating a UI 600 for generating a report according to an embodiment of the subject matter described herein. In some embodiments, case management module 110 can generate and/or provide a GUI for analyzing files and/or entire folders and for making notes or annotations. In some embodiments, UI 600 may be a web-based UI and may use hypertext markup language (HTML) or other web related technology. As illustrated in FIG. 6, UI 600 may provide user interface elements for performing various actions associated with generating a report containing information related to imported files or folders. In some embodiments, UI 600 may provide UI elements that are interactive and/or allow a user to interact with various imported files. For example, UI 600 may provide a UI element for select a report type from a plurality of report types that can be generated. In this example, each report types may have different configurable options and/or different default values, e.g., files and/or folders to be included, types of files or folders to be included, categories to be included, report formatting, and/or report file format.

In some embodiments, UI 600 may provide UI elements that are interactive and/or allow a user to interact with case management module 110 or a related entity. For example, after selecting “Notes Report” as a report type to be generated, UI 600 may provide UI elements for configuring a report and its content. In this example, UI 600 may provide UI elements for inputting a begin date and an end date for filtering content that does not meet any inputted date criteria, for selecting notes based on selected note categories, for selecting documents based on selected document categories, and/or for selecting specific documents.

In some embodiments, UI 600 may provide UI elements for generating a report and/or for opening and/or saving the report. For example, UI 600 may provide a button UI element for trigger report generation. In this example, UI may also provide a checkbox UI element for opening the report after generation. Continuing with this example, UI 600 may also provide or trigger a save dialog UI element for saving the report file in a particular location and/or in a particular file format.

It will be appreciated that UI 600 is for illustrative purposes and that different UI elements and layout designs may be used for receiving input and/or for providing actions, feedback, or information to users.

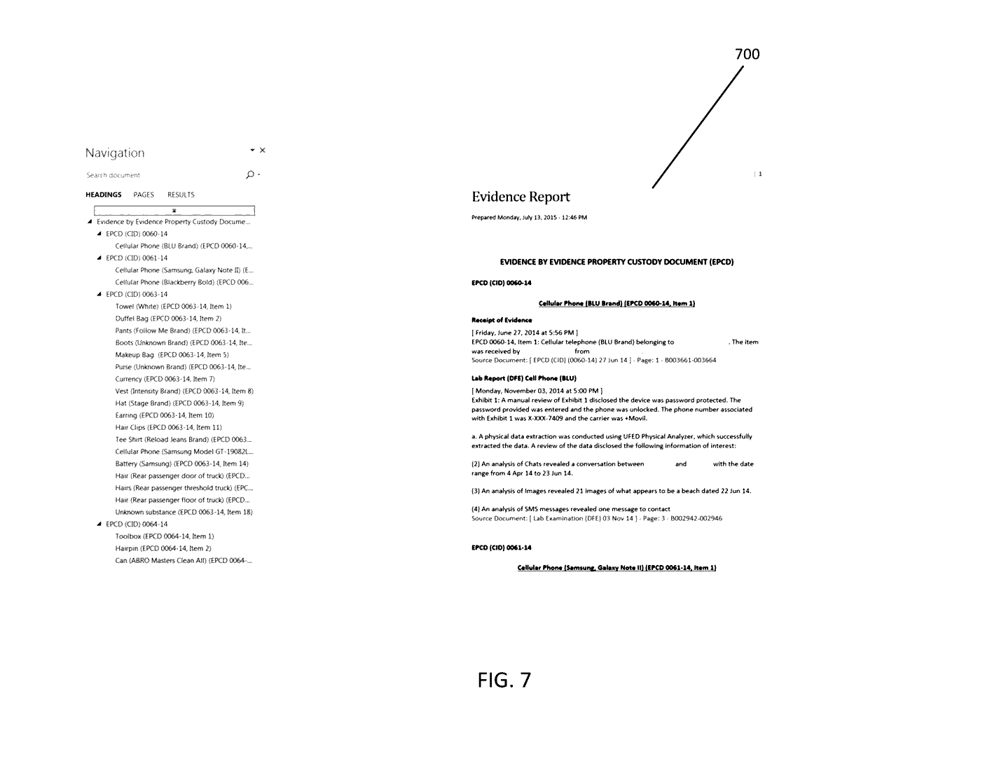

FIG. 7 is a screenshot illustrating a generated report 700 according to an embodiment of the subject matter described herein. In some embodiments, report 700 may include at least some information compiled, obtained, or derived from one or more imported files and/or notes inputted by a user. For example, report 700 may represent an evidence report containing notes about various evidence related files.

In some embodiments, when generating report 700, case management module 110 may format a report in a hierarchical manner as determined by user-provided classifications, categories, and/or groupings. For example, as depicted in FIG. 7, a main heading may be used to identify a particular evidence related file, e.g., an evidence property custody document (EPCD), one or more sub-headings may be used to identify particular evidence items listed in the evidence related file, and one sub-sub-headings may be used for various notes or annotations about the evidence items.

In some embodiments, report 700 may include notes and/or annotations about various files or portions thereof (e.g., a page or an evidence item described therein). In some embodiments, report 700 may also include information (e.g., a filename or a hyperlink) for identifying a source file for one or more notes. For example, where report 700 is a word document or a PDF file that allows hyperlinks, report 700 may include a hyperlink that when activated opens a source document via case management module 110 or another application. In another example, where report 700 is a word document or a PDF file that does not allow hyperlinks, report 700 may include reference or citation information to a source document in an appropriate citation format or style.

It will be appreciated that report 700 is for illustrative purposes and that different formatting and layout designs may be used when generating reports using case management module 110 or another related entity.

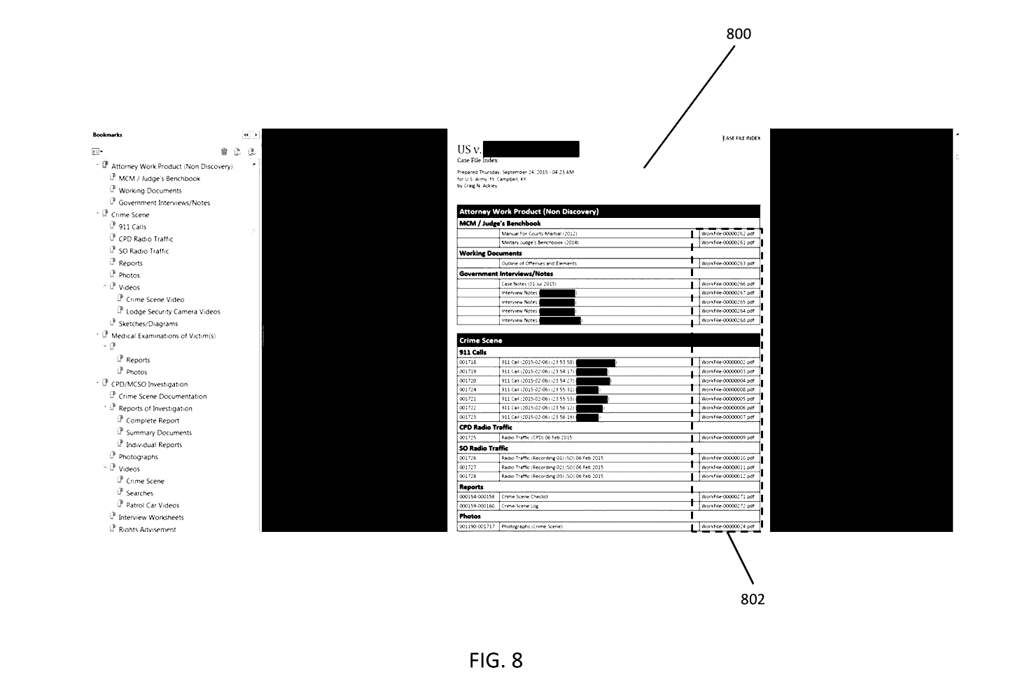

FIG. 8 is a screenshot illustrating a report 800 containing a case file index according to an embodiment of the subject matter described herein. In some embodiments, report 800 may include at least some information compiled, obtained, or derived from one or more imported files and/or notes inputted by a user. For example, report 800 may represent a “case file” and may contain an organized case file index, e.g., links 802 to multiple documents or other files associated with a legal matter.

In some embodiments, when generating report 800, case management module 110 may format a report in a hierarchical manner as determined by user-provided classifications, categories, and/or groupings. For example, as depicted in FIG. 8, main headings may be used to identify categories of files (e.g., “Attorney Work Product”, “Crime Scene”, “Medical Examinations of Victim(s), and/or “Police Investigation”); sub-headings may be used to identify particular files or information types (e.g., “Reports”, “Photos”, “Videos”, and “911 Calls”); and sub-sub-headings and beyond may be used for further distinguishing among certain information (e.g., “Crime Scene Video” and “Lodge Security Camera Videos”).

In some embodiments, a case file index in report 800 may include links 802 (e.g., hyperlinks) to external files or pages in report 800. For example, report 800 may act as a directory or table of contents for various files and/or pages associated with a case, e.g., a legal proceeding. In this example, report 800 may utilize a tabular format, e.g., each table in report 800 may include file related information associated with a particular category, and each row in the table may include metadata (e.g., a bates stamp number, a description, and/or a date) about a particular file and a link for opening or viewing the particular file.

In some embodiments, when generating report 800, case management module 110 may store at least one linked-to file in a discernible and portability-friendly location, e.g., a local file folder, an encapsulating file, or a data structure. For example, linked-to files in report 800 may be stored external to or separate from report 800, such as in a discernible file folder. In this example, a PDF file containing report 800 along with the file folder containing linked-to files may be copied to a flash drive, a CD, or another storage media for portability. In another example, linked-to files in report 800 may be stored internal to or in a file encapsulating report 800, such as a word document being converted into pages in a PDF file containing report 800. In this example, the PDF file may be copied to a flash drive, a CD, or another storage media for portability.

It will be appreciated that report 800 is for illustrative purposes and that different formatting and layout designs may be used when generating reports using case management module 110 or another related entity.

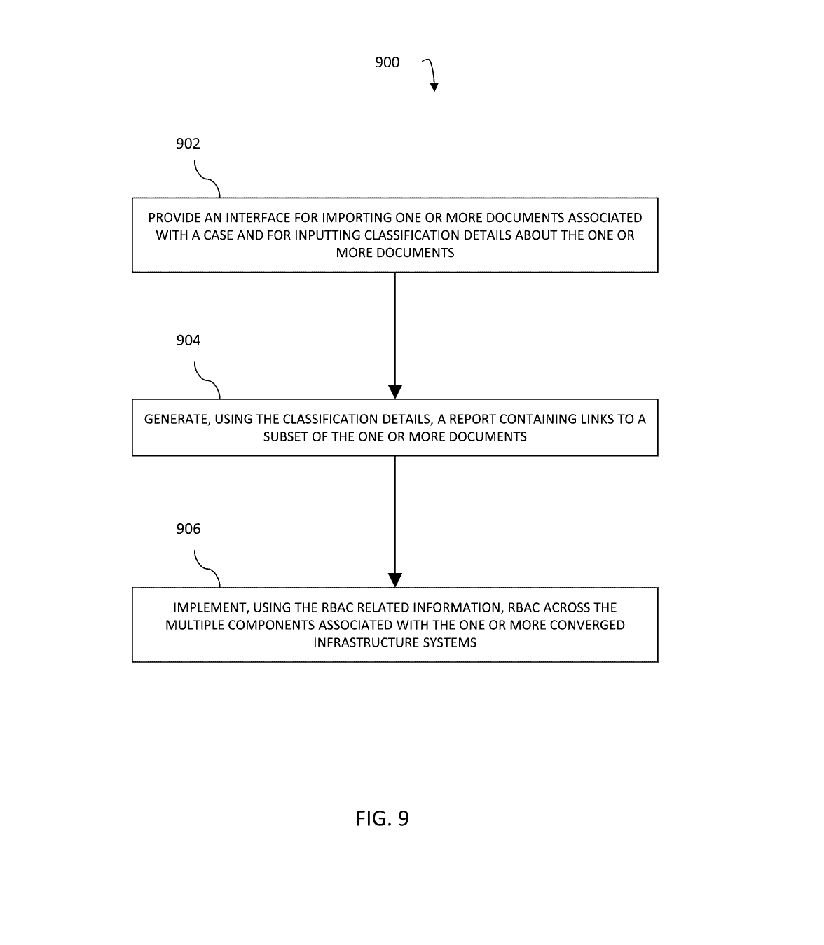

FIG. 9 is a diagram illustrating a process 900 for optimized case management according to an embodiment of the subject matter described herein. In some embodiments, process 900, or portions thereof, may be performed by or at computer system 100 (e.g., a case management device or a computer), case management module 110, and/or another node or module. In some embodiments, process 900 may include steps 902, 904, and/or 906.

At step 902, an interface for importing one or more documents associated with a case (e.g., an event, a matter, a legal matter, a trial, or a client matter) and for inputting classification details about the one or more documents may be provided. For example, a GUI may provide various user interface elements, such as text boxes and selection boxes, for inputting classification details and/or user preferences regarding report formatting and/or case management optimizations. In another example, a GUI may include a file selection dialog for selecting one or more files to import and/or convert.

In some embodiments, importing one or more documents may include generating a link encapsulating document (e.g., which may act as a placeholder) for accessing a video file, a sound file, an image file, or a non-text based file.

In some embodiments, importing one or more documents may include converting and/or generating a document based on a file or document associated with another format.

In some embodiments, importing one or more documents may include generating one or more bates stamps for imported one or more documents.

In some embodiments, classification details may include a case related category, a witness related category, an evidence related category, an intent related category, a motive related category, a timeline related category, an investigator related category, a data type category, a source related category, or a destination related category.

At step 904, a report containing links to a subset of the one or more documents may be generated using the classification details. In some embodiments, links in a report may be ordered based on the classification details. For example, using classification details, a report file may include links in a hierarchical manner as determined by user-provided classifications, categories, and/or groupings.

In some embodiments, a report file may include a portable case index containing links to multiple documents or other files associated with a case, event, or matter.

In some embodiments, generating, using classification details, a report may include organizing the report based on classification details and/or user preferences.

In some embodiments, generating, using classification details, a report may include determining a subset of one or more documents based on classification details and/or user preferences.

In some embodiments, generating, using classification details, a report may include searching classification details for user-defined search criteria and identifying a subset of one or more documents that are associated with the classification details that include the user-defined search criteria.

In some embodiments, links in a report may include a hyperlink for displaying a document separate from the report or a location in the report. For example, clicking a link may open a particular document in a PDF reader or a web browser application.

At step 906, the report may be provided, to a requesting entity. For example, a report may include a PDF file containing hyperlinks to various other PDF files representing information about a case. In this example, the report and the various other PDF files may be stored in a folder and may be burned to a CD or stored on a flash drive for portability and/or ease of access.

In some embodiments, providing a report may include providing the report and one or more documents (e.g., a file folder containing linked-to files associated with the report) in a portable format or a PDF format.

It should be noted that computer system 100, case management module 110, and/or functionality described herein may constitute a special purpose computing device. Further, computer system 100, case management module 110, and/or functionality described herein can improve the technological field of data management by providing efficient methods and/or techniques for organizing and/or correlating data involving files in various data types and file formats. Further, by providing reports containing links to various source files, computer system 100, case management module 110, and/or functionality described herein can provide case management that is significantly more user friendly than existing case management systems. Further, by generating reports and storing links in discernible and portability-friendly locations, case management module 110, and/or functionality described herein can provide output that is significantly more portability and/or customized over existing case management systems

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for optimized case management, the method comprising:
providing an interface for importing one or more documents associated with a case and for inputting classification details about the one or more documents;
generating, using the classification details, a report containing links to a subset of the one or more documents, wherein the links in the report are ordered based on the classification details; and
providing, to a requesting entity, the report.

2. The method of claim 1 wherein providing the interface includes importing the one or more documents and generating a link encapsulating document as a placeholder for accessing a video file, a sound file, an image file, or a non-text based file associated with the case.

3. The method of claim 1 comprising:
generating one or more bates stamps for the one or more documents.

4. The method of claim 1 wherein providing, to a requesting entity, the report includes providing the report and the one or more documents in a portable format or a portable document format (PDF).

5. The method of claim 1 wherein generating, using the classification details, the report includes organizing the report based on the classification details or user preferences.

6. The method of claim 1 wherein generating, using the classification details, the report includes determining the subset of the one or more documents based on the classification details or user preferences.

7. The method of claim 1 wherein generating, using the classification details, the report includes searching the classification details for user-defined search criteria and identifying the subset of the one or more documents that are associated with the classification details that include the user-defined search criteria.

8. The method of claim 1 wherein the links include a hyperlink for displaying a document separate from the report or a location in the report.

9. The method of claim 1 wherein the classification details includes a case related category, a witness related category, an evidence related category, an intent related category, a motive related category, a timeline related category, an investigator related category, a data type category, a source related category, or a destination related category.

10. A system for optimized case management, the system comprising:
at least one processor;
a memory; and
a case management module utilizing the at least one processor and memory, wherein the case management module is configured to provide an interface for importing one or more documents associated with a case and for inputting classification details about the one or more documents, to generate, using the classification details, a report containing links to a subset of the one or more documents, wherein the links in the report are ordered based on the classification details, and to provide, to a requesting entity, the report.

11. The system of claim 10 wherein the case management module is configured to generate a link encapsulating document as a placeholder for accessing a video file, a sound file, an image file, or a non-text based file associated with the case.

12. The system of claim 10 wherein the case management module is configured to generate one or more bates stamps for the one or more documents.

13. The system of claim 10 wherein the case management module is configured to provide the report and the one or more documents in a portable format or a portable document format (PDF).

14. The system of claim 10 wherein the case management module is configured to organize the report based on the classification details or user preferences.

15. The system of claim 10 wherein the case management module is configured to determine the subset of the one or more documents based on the classification details or user preferences.

16. The system of claim 10 wherein the case management module is configured to search the classification details for user-defined search criteria and identify the subset of the one or more documents that are associated with the classification details that include the user-defined search criteria.

17. The system of claim 10 wherein the links include a hyperlink for displaying a document separate from the report or a location in the report.

18. The system of claim 10 wherein the classification details includes a case related category, a witness related category, an evidence related category, an intent related category, a motive related category, a timeline related category, an investigator related category, a data type category, a source related category, or a destination related category.

19. A non-transitory computer readable medium having stored thereon executable instructions that when executed by a processor of a computer causes the computer to perform steps comprising:
providing an interface for importing one or more documents associated with a case and for inputting classification details about the one or more documents;
generating, using the classification details, a report containing links to a subset of the one or more documents, wherein the links in the report are ordered based on the classification details; and
providing, to a requesting entity, the report.
